(19) United States
(12) Patent Application Publication
(10) Pub. No.: US 2025/0335700 A1
(43) Pub. Date: Oct. 30, 2025

(54) APPARATUS, METHOD AND COMPUTER PROGRAM PRODUCT FOR CONTENT SUBMISSION

(71) Applicant: HUAWEI TECHNOLOGIES CO., LTD., Shenzhen (CN)

(72) Inventors: Adrian Flanagan, Helsinki (FI); Kuan Eeik Tan, Helsinki (FI)

(73) Assignee: HUAWEI TECHNOLOGIES CO., LTD., Shenzhen (CN)

(21) Appl. No.: 19/259,973

(22) Filed: Jul. 3, 2025

Related U.S. Application Data
(63) Continuation of application No. PCT/EP2023/050099, filed on Jan. 4, 2023.

(51) Int. Cl. G06F 40/166; G06F 18/241

(52) U.S. Cl. CPC G06F 40/166; G06F 18/241

(57) ABSTRACT

An apparatus, a method and a computer program product for content submission is disclosed. Provision of a content is facilitated. A classification model, stored within an at least one memory, is utilized to provide at least one classification score for the content to indicate whether the content conforms with moderation. Based on the at least one classification score, submission of the content from the apparatus to at least one external system for publication is facilitated.

### CROSS-REFERENCE TO RELATED APPLICATIONS

This application is a continuation of International Application No. PCT/EP2023/050099 filed on Jan. 4, 2023, the disclosure of which is hereby incorporated by reference in its entirety.

### TECHNICAL FIELD

Embodiments of this application relate to the field of electronic publication, in particular to automatized content moderation therefor.

### BACKGROUND

User content (e.g. texts, comments, images) may be provided from a user device and submitted to an external system, such as an online service, to appear in public. Such content is often subject to content moderation on the service provider's side. The moderation can be used to ensure that the content conforms to the service provider's guidelines and standards. The moderation can be carried out automatically, for example by using machine learning models, and/or manually by human moderators. After submission the user's content can be accepted or rejected for publication in the online service. From the perspective of the user, the moderation process may be confusing and ineffective. The user may not realize their content has breached guidelines and may be offended or embarrassed by the service's rejection of their content.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the invention to provide moderation before the user has submitted the content.

The foregoing and other objects may be achieved by the features of the independent claims. Further implementation forms are apparent from the dependent claims, the description and the figures.

According to a first aspect, an apparatus for content submission is provided. The apparatus may comprise at least one memory storing processor-executable instructions and at least one processor coupled to the at least one memory. The at least one processor may be configured, when executing the processor-executable instructions to perform the following. First, facilitating provision of a content. Second, utilizing a classification model, stored within the at least one memory, to provide at least one classification score for the content to indicate whether the content conforms with moderation. Third, based on the at least one classification score, facilitating submission of the content from the apparatus to at least one external system for publication.

The solution as disclosed allows a real-time moderation decision to be provided, optionally with feedback to the user. The feedback may include but is not limited to reason for rejection. Moreover, the solution as disclosed allows improved preservation of the user's privacy. As the moderation can be performed on the user device, the user is not forced to submit any content to the external system(s) that has not been approved for publication. Furthermore, an option may be provided to the user to modify their content in a way that is acceptable in view of the moderation. This may be done already at the user device, without the content having been transmitted from the user device. The apparatus may be configured for performing the automatic moderation before the content is submitted or even tried to be submitted from the apparatus to the external system(s).

In an implementation form, the at least one processor is configured, when executing the processor-executable instructions, to facilitate submission of the content from the apparatus to the at least one external system for human moderation. This allows the artificial intelligence for automatized moderation of the apparatus to be supplemented by human intelligence at the external system.

In an implementation form, the at least one processor is configured, when executing the processor-executable instructions, to facilitate the submission of the content from the apparatus to the at least one external system for human moderation if the at least one classification score is higher than or equal to a first threshold value and lower than or equal to a second threshold value, the second threshold value being higher than the first threshold value. This allows the classification score to be utilized as a certainty threshold so that values of the classification score outside the range from the first threshold value to the second threshold value may correspond to a certain approval or rejection decision for publication of the content, whereas values of the classification score within the range from the first threshold value to the second threshold value may correspond to an uncertain moderation. For uncertain moderation, an option of human moderation at the external system may be provided.

In an implementation form, the at least one processor is configured, when executing the processor-executable instructions, only facilitate the submission of the content from the apparatus to the at least one external system for human moderation based on an input from a user of the apparatus. This allows the privacy of the user to be preserved in a controlled manner. The user may be notified that the outcome of the moderation at the user device is unsure and an explicit input from the user may be required to allow the content to be transmitted from the apparatus.

In an implementation form, the at least one processor is configured, when executing the processor-executable instructions, to facilitate the submission of the content from the apparatus to the at least one external system for publication if the at least one classification score fulfils at least one threshold criterion, which may be referred to as a first threshold criterion. This allows the apparatus to approve the content for publication. No further moderation at the external system is thus required. This also allows the user to be confident that the content can be safely transmitted from the apparatus for publication.

In an implementation form, the at least one processor is configured, when executing the processor-executable instructions, to prevent the submission of the content from the apparatus to the at least one external system for publication if the at least one classification score fulfils at least one threshold criterion, which may be referred to as a second threshold criterion. This allows the apparatus to reject the content for publication. No further moderation at the external system is thus required, although the apparatus may be configured to offer a voluntary opportunity also for further moderation at the external system in this case. This also allows the user to be confident that the content has not been transmitted from the apparatus to the external system, when rejected.

In an implementation form, the at least one processor is configured, when executing the processor-executable instructions, to prevent, based on the at least one classification score, the submission of the content from the apparatus to the at least one external system for publication and, instead, prompt a user of the apparatus to modify the content to provide a modified content. This allows the content to be adapted to the moderation requirements of the external system, even substantially in real time. Accordingly, the moderation can be performed automatically in real time while the content may be adapted in real time where necessary.

In an implementation form, the at least one processor is configured, when executing the processor-executable instructions, to provide at least one automated suggestion for the user for the modified content. This allows automatized feedback to be provided to the user so that the content can be adapted to the moderation requirements of the external system.

In an implementation form, the at least one processor is configured, when executing the processor-executable instructions, to perform obfuscation detection for the modified content. This allows the apparatus to recognize, for moderation, if the modifications made to the modified content are only superficial in that they do not actually remove the reason for rejection of the content. For this, no human moderation at the external system is required either.

In an implementation form, the at least one processor is configured, when executing the processor-executable instructions, in response to the prevention of the submission of the content from the apparatus to the at least one external system for publication, to facilitate the submission of the content from the apparatus to the at least one external system for human moderation based on an input from a user of the apparatus. This allows the apparatus to function as the primary moderator while also facilitating retrieval of a second opinion, for example when the outcome of the moderation at the apparatus does not meet a certainty threshold.

According to a second aspect, a method for content submission is disclosed. The method may comprise facilitating provision of a content at an apparatus. It may also comprise utilizing a classification model, at the apparatus, to provide at least one classification score for the content to indicate whether the content conforms with moderation. The method may comprise, based on the at least one classification score, facilitating submission of the content from the apparatus to at least one external system for publication What is stated in connection of the first aspect or any of its implementation forms applies also to the second aspect.

According to a third aspect, a computer program product is disclosed. The product comprises instructions which, when executed by an apparatus, cause the apparatus to perform the method according to the second aspect.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates an apparatus according to an example,

FIG. 2 illustrates content moderation according to an example,

FIG. 3 illustrates content moderation according to another example, and

FIG. 4 illustrates a method according to an example.

In the following, identical reference signs refer to identical or at least functionally equivalent features.

### DETAILED DESCRIPTION

In the following description, reference is made to the accompanying drawings, which form part of the disclosure, and in which are shown, by way of illustration, specific aspects in which the invention may be placed. It is understood that other aspects may be utilized, and structural or logical changes may be made without departing from the scope of the invention. The following detailed description, therefore, is not to be taken in a limiting sense, as the scope of the invention is defined in the appended claims.

For instance, it is understood that a disclosure in connection with a described method may also hold true for a corresponding apparatus, device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

As will be discussed in more detail below, the disclosed embodiments may allow automatized content moderation at a user device.

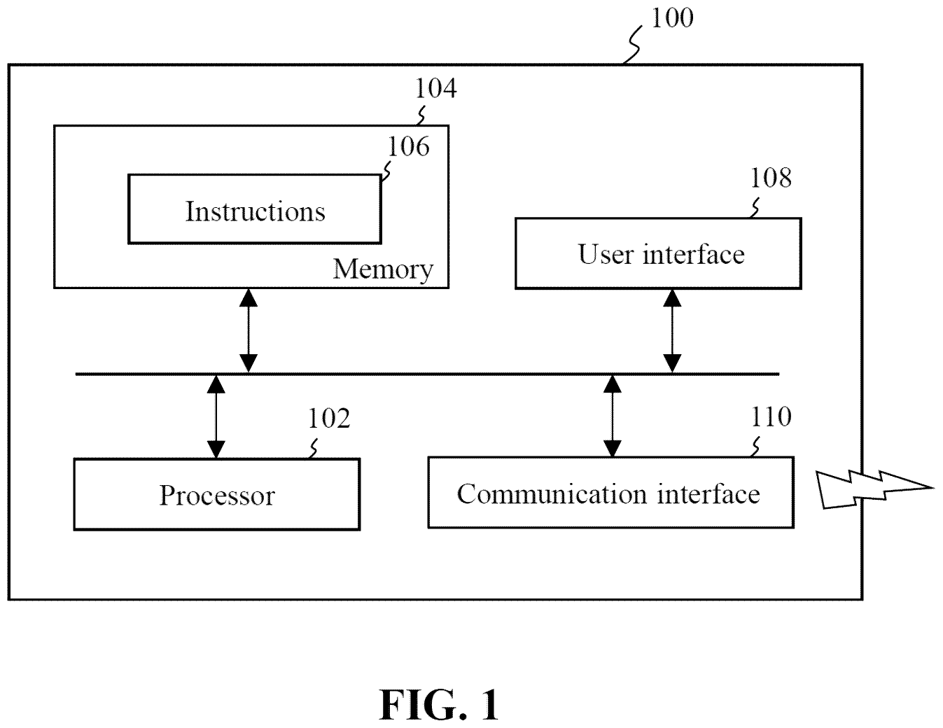

FIG. 1 illustrates an apparatus 100 according to an example. The apparatus may also be referred herein as to the user device. The apparatus may comprise one or more processors 102 and one or more memories 104. The one or more memories may store processor-executable instructions 106. The apparatus may also include other elements not shown in FIG. 1.

The one or more processors 102 may be coupled to the one or more memories 104. The processor(s) may also be configured for executing the instructions 106, In an embodiment, the processor(s) may be embodied as a multi-core processor(s), a single core processor(s), or a combination of one or more multi-core processors and one or more single core processors. In an embodiment, the processor(s) may be configured to execute hard-coded functionality. In an embodiment, the processor(s) may be provided as an executor of software instructions.

The one or more memories 104 may be embodied as one or more volatile memory devices, one or more non-volatile memory devices, and/or a combination of one or more volatile memory devices and non-volatile memory devices. For example, the one or more memories may be embodied as semiconductor memories (such as mask ROM, PROM (programmable ROM), EPROM (erasable PROM), flash ROM, RAM (random access memory), etc.).

The apparatus 100 may comprise a user interface 108. The user interface may comprise a keyboard, a keypad, a touch screen, a voice-control interface or any combination thereof. The apparatus may be configured for providing content. The apparatus may be configured for facilitating generation of the content, for example through the user interface. The apparatus may also comprise a microphone and/or a camera (for capturing still images and/or video) for providing the content. The content may be provided by any combination of the following: generated at the apparatus, modified at the apparatus, relayed by the apparatus. The apparatus can thus provide the content directly, as a content generator, and/or indirectly, as a content relay.

The apparatus may comprise a communication interface 110 for transmitting the content from the apparatus. The communication interface may also allow receiving content, for example to be relayed or modified by the apparatus. The communication interface may comprise a wireless and/or a wired interface. For example, the communication interface may comprise any combination of a local area network (LAN) interface, a wide area network (WAN) interface, a mobile phone network interface and a short-range wireless communication interface such as a Bluetooth interface.

The apparatus 100 may be a computing device or a part thereof. In an embodiment, the apparatus is a mobile computing device. For example, the apparatus may be a personal computer (PC), a laptop computer, a mobile phone (e.g. a smart phone), a tablet computer or a wearable computing device (e.g. a watch or a headset).

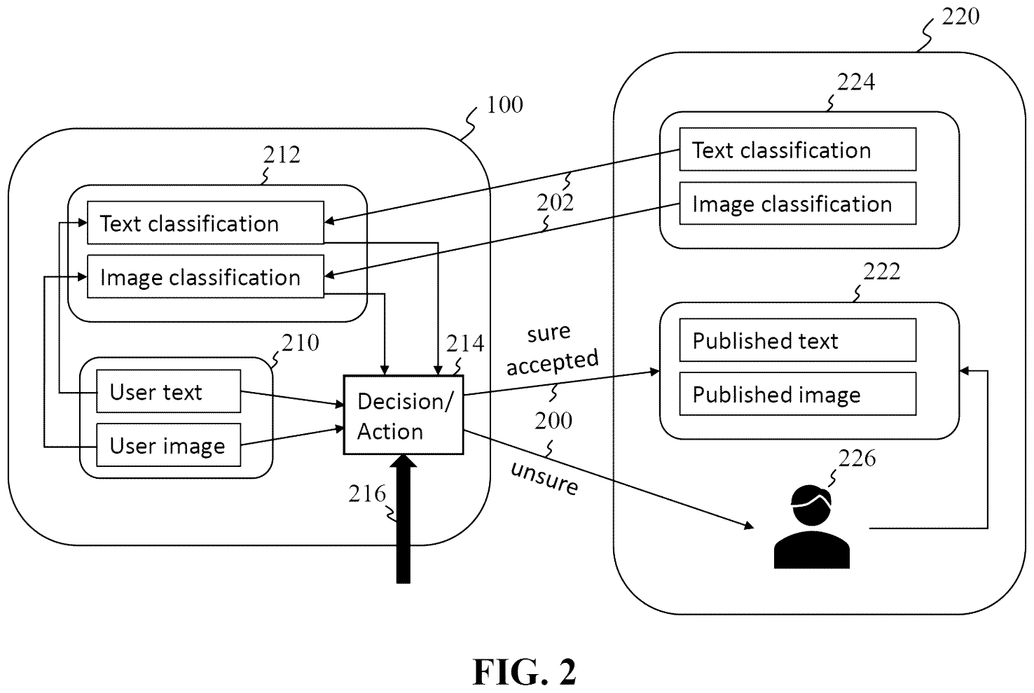

FIG. 2 illustrates content moderation according to an example. The moderation may be partially or fully performed by the apparatus 100 as described above. The apparatus 100 may be configured for content submission. This may involve submission 200 of a content 210 to one or more external systems 220 for publication. The external system(s) may be configured for providing an online publication service. The external system(s) may comprise one or more servers, such as online publication servers, for publication of the content. The submission of the content may thus also correspond uploading the content to the external system(s).

The apparatus 100 may specifically be configured for submitting the content 210 to the external system(s) 220. Thus, even if the content originates from one or more sources outside the apparatus, it is the apparatus that is used for submitting the content to the external system(s). For this purpose, the apparatus may be configured to use submitting means for the external system(s), where the submitting means may correspond to a computer program product e.g. a browser or an application, such as a smart phone application. These may be provided by one or more service providers of the external system(s). These submitting means may be stored within the one or more memories.

The content 210 may comprise textual content, audible content, visual content or any combination of these. For example, it may comprise a comment to an online discussion, an article, an image, a video or any combination of these. The moderation may be performed to detect, whether the content is abusive or in some other way does not conform with moderation, in particular with respect to the moderation requirements of the external system(s).

The content moderation may involve receiving 202 classification data at the apparatus 100. The classification data may be provided from the external system(s) 220, where it may be stored and/or modified as system classification data 224. The classification data may be received at the apparatus through the communication interface 110. It may be stored in the one or more memories 104. The classification data may comprise a classification model 2t2 or instructions for providing the classification model at the user device. The classification model may be based on artificial intelligence, e.g., on machine learning. Various artificial intelligence models available to a person skilled in the art can be utilized for this purpose. The classification model may be configured for text and/or image classification. Separate models may also be provided for text and image classification. Accordingly the classification data may comprise multiple classification models, each of, which may be configured for a different purpose.

The classification model(s) 212 are stored within the apparatus 100, thereby allowing automated local classification of the content 210. Similarly, local moderation of the content becomes possible at the apparatus. This can be done automatically based on any explicit and/or implicit rules embedded into the classification model(s). The moderation can thus be performed by the one or more processors 102 based on the classification model(s), which may be stored within the one or more memories 104. No further interaction between the apparatus and any external system is necessarily required for the moderation. At the apparatus 100, the classification model(s) may be configured purely for inference. They may comprise multiple models each having a single output, thereby separating different categories. They may also comprise a single model having multiple outputs, thereby separating different categories.

The apparatus 100 may be configured to automatically provide a decision for moderation. For this purpose, one or more decision variables may be used to provide one or more classification scores 214. Additionally or alternatively, one or more actions may be automatically generated or requested. The decision may be to allow (also “approve”) the content to be submitted 200 to the external system(s) 220 for publication or to reject the submission of the content to the external system(s) for publication. The decision may be based on the value of the classification score(s), e.g. with one, two or more threshold values of the classification score(s) indicating different actions by the apparatus depending on whether the classification score assumes a value higher or lower with respect to the threshold value(s). The apparatus may be configured to automatically act on the decision, for example by submitting the content to the external system(s) for publication. For this purpose, the communication interface 110 may be used.

The decision may also indicate certainty for the decision. Such a certainty indicator may be integral to the decision variable(s). This may be achieved, for example so that a single decision variable indicates certainty and if a (first) certainty threshold is passed so that the content is evaluated to conform with the moderation, the decision is to approve, as stated above. On the contrary, if a (second) certainty threshold is passed so that the content is evaluated not to conform with the moderation, the decision can be to reject, as stated above. Passing the first certainty threshold may here indicate a value of the decision variable (in particular the classification score) being below the first certainty threshold, whereas passing the second certainty threshold may indicate the value of the decision variable being above the second certainty threshold. However, it should be understood that the this can be just a convention so that the directionality for the certainty indicator may also be reversed, i.e. so that the words “below” and “above” in the previous sentence are interchanged. If neither of the (first and second) certainty thresholds is passed, e.g. so that the value of the decision variable is between the first certainty threshold and the second certainty threshold, the decision may be that it has not been established whether the content conforms with the moderation. This may also be referred herein as the decision being “unsure”. In such a case, a further action may be requested from the user. As an example, the decision variable may be a real-valued variable. It may be normalized so that it can assume values from 0 to 1. In this example, values of the variable below a lower threshold (e.g. 0.35) correspond to a classification score that may be taken to indicate that the content conforms with the moderation (and can be automatically submitted by the apparatus to the external system for publication), whereas values above an upper threshold (e.g. 0.6) may be taken to indicate that the content does not conform with moderation (and its submission to the external system for publication can be automatically blocked by the apparatus). Any values between the lower and the upper threshold may be taken to indicate that the decision is unsure. The value for the decision variable can be directly obtained from the classification model(s) as a classification score of the corresponding model(s).

In general, the apparatus may be configured for requesting one or more user inputs 216 for moderation. In particular, such a user input may be (automatically) requested in response to the decision being rejection or unsure. When the decision is unsure, the apparatus may prompt the user input to be provided for the content to be submitted 200 to the external system 220 for further moderation, e.g. by a human moderator. Thus the privacy of the user regarding unallowable content is not breached against the will and knowledge of the user. When the decision is a rejection, that passes the threshold for certainty, the apparatus may still prompt the user input to be provided for the content to be submitted 200 to the external system 220 for further moderation, e.g. by a human moderator. This allows a second opinion to be obtained from the external system. In either or both of the abovementioned cased, the apparatus may be configured to allow further information to be submitted together with the content, for example arguments of the user. The user input may be provided through the user interface 108.

The content 210, when approved at the apparatus 100, and submitted to the external system(s) 220, may be automatically published 222 at the external system(s). Alternatively, it may be published after the further moderation 226, e.g. by a human moderator.

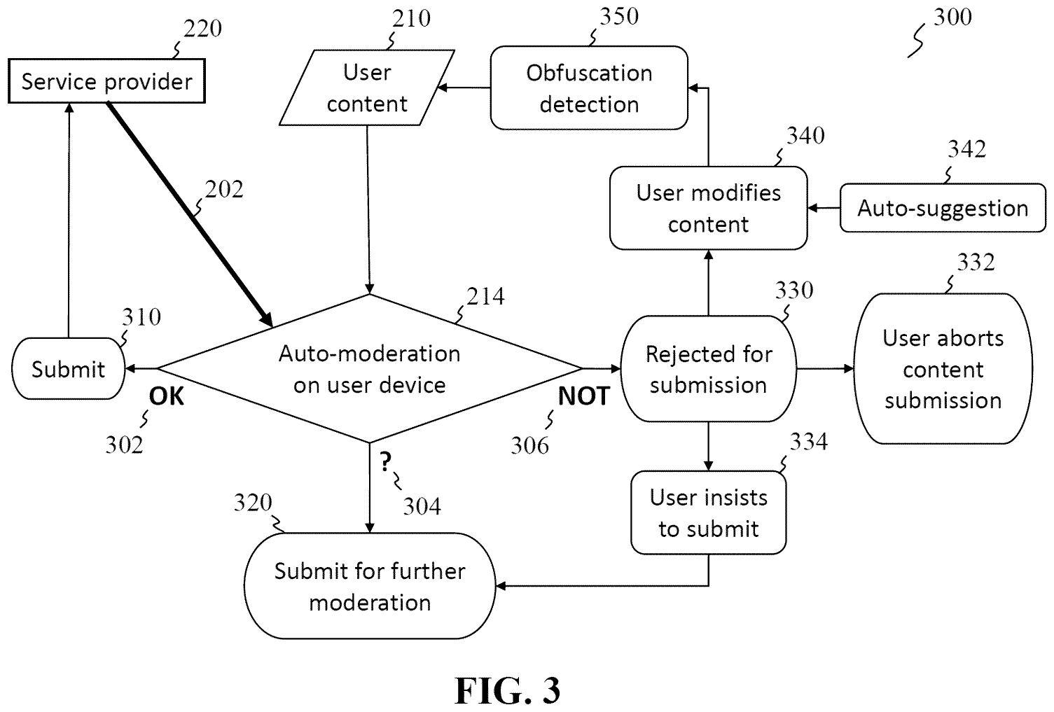

FIG. 3 illustrates content moderation 300 according to another example. This example is interchangeable with the example(s) illustrated in connection of FIG. 2. Any or all features disclosed in connection of any of the examples can be used also in connection of any other of the examples.

The content 210 can be provided by the apparatus 100, as described above. This content can be user content generated, modified or relayed by the user of the apparatus. The classification data for the classification model(s) can be received, e.g., downloaded, by the apparatus from the external system(s) 220, which may correspond to one or more service providers. Automatic moderation can then be performed 214, based on the content and the classification model(s), on the apparatus. If the decision is positive 302 (e.g. resulting to a classification score indicating that the content is approved), the content can be submitted 310 to the external system(s) for publication without any further checks. This may be done automatically without further input from the user. This decision may also be referred to as being non-abusive-sure. If the decision is unsure 304 (e.g. resulting to a classification score indicating that the content is neither approved nor rejected), the apparatus may submit the content to the external system(s) for further moderation 320, e.g. by a human moderator. This submission may be conditional on the apparatus receiving an approval for submission by user input. This decision may also be referred to as being abusive-unsure. If the decision is negative 306 (e.g. resulting to a classification score indicating that the content is rejected), the submission of the content to the external system(s) for publication may be blocked 330, thereby rejecting the submission. This may involve the apparatus to prevent transmission of the content from the apparatus to the external system(s), e.g. by the communication interface. This decision may also be referred to as being abusive-sure. This may result in the user aborting 332 the submission of the content, in which case the content may be deleted or stored within the one or more memories of the apparatus.

The apparatus 100 may be configured to provide the user one or more options for the content even after the decision of rejection. The apparatus may be configured to allow the user to insist 334 the content be submitted in spite of the abusive-sure classification. In response to an user input indicating this, the apparatus may then submit the content for further moderation 320, e.g. by a human moderator. For this purpose, the apparatus may be configured to facilitate transmission of the content to the external system(s), e.g. utilizing the communication interface of the apparatus. Alternatively or additionally, the apparatus may be configured to allow the content to be modified 340 at the apparatus in order to have it conform with the moderation. For this purpose, the apparatus may be configured to automatically provide one or more suggestions 342 for the modified content. As an example, when the content is textual, the apparatus may suggest one or more emojis for the modified content to express different types of emotions in a manner conforming with the moderation. Such automatic suggestions may be termed non-abusive suggestions, e.g. non-abusive emojis.

The apparatus 100 may be configured to perform obfuscation detection 350 on the modified content. This allows confirming that the content is not modified only in a superficial manner but that the underlying reason for the rejection has been removed before the modified content is approved for submission to the external system(s) for publication. In other words, it can be checked whether the abusive content has been obfuscated rather than removed. For the obfuscation detection, any method known and available to the person skilled in the art may be used. The obfuscation detection may be performed after the modified content is finished, e.g. when the user tries to (re-)submit the modified content for publication. The apparatus may be configured to submit the modified content to the external system(s) for publication only if it passes the obfuscation detection. Also, the moderation 214 may be restarted again for the modified content. This way, the final submission criteria for the submission 310 for publication for the modified content can be maintained the same as for the original content. The modified content may thus be subjected to two checks: first the obfuscation detection 350 and then the automatic moderation 214. The modified content may thus be allowed to proceed to the automatic moderation only if it passes the obfuscation detection, thereby providing an improved safeguard for the moderation.

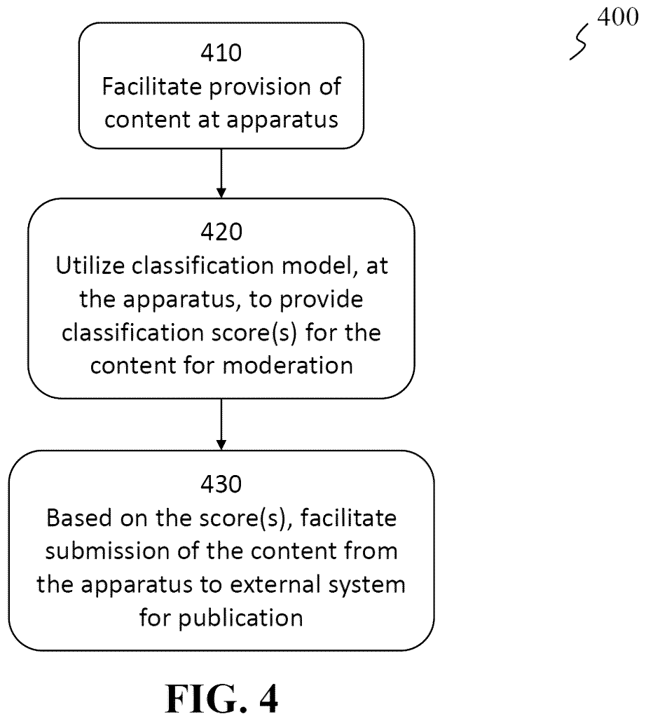

FIG. 4 illustrates a method 400 according to an example. The method can be utilized for content submission, where the content to be submitted can be automatically moderated at a user device, such as the apparatus 100 disclosed herein. The method may comprise facilitating 410 provision of a content at an apparatus. The method may also comprise utilizing 420 a classification model, at the apparatus, to provide at least one classification score for the content to indicate whether the content conforms with moderation. The method may then comprise, based on the at least one classification score, facilitating 430 submission of the content from the apparatus to at least one external system for publication.

In an embodiment, a method of privacy preserving auto-moderation and correction on user device, such as the apparatus 100 described herein, is provided. This can allow improved preservation of user's privacy and reputation. One or more classification models as content moderation models may be downloaded from one or more external systems, which may correspond to (online) service providers, to the user device. As a result, the service provider does not need to handle potentially illegal content. User's content can remain with the user until it has been confirmed to conform with the moderation or until the user has explicitly indicated, on a case-by-case basis, that the content can be transmitted from the user device even when it has been flagged as abusive or potentially abusive (abusive-unsure).

Automated content moderation of the user's content can take place on the user device. For the content, or for each individual item thereof, this can result in a decision based on a classification score of the classification model(s). This may involve classification of the classification score itself as sure or unsure. No human interaction is required for the moderation apart from the user indicating their preference to submit the content. The user may receive immediate feedback from the device-side automated moderation on whether the content conforms with moderation, e.g. whether it is abusive or not. In general, the lag time in getting a decision on moderation and/or content classification can be reduced, even so that the feedback is substantially real-time feedback. If the content is not abusive-sure, it can be submitted to the external system(s) for publication. In general, the lag time in getting the content published at the external system(s) can be reduced, even so that the publication is substantially real-time publication.

If the automated moderation system, as described herein and provided within the user device, is unsure (which can be referred to as abusive-unsure), the content can be submitted for further moderation to the external system(s), in particular for human moderation. This can substantially reduce the load on human moderators at the external system(s). The user device can be configured so that if the content is abusive-sure then the user is unable to submit the content to the external system(s). Thus, the service provider does not need to handle potentially illegal content. User's content can remain with the user at the user device. For content considered abusive-sure, the moderation model may provide feedback on which content (or which part of the content) is abusive and the user can be provided with the option to modify (edit/change) the content to produce a modified content to change the auto-moderation decision and allow for submission to the external system(s) for publication. This can allow the user to become aware of the guidelines on appropriate content at the external system(s) through the feedback. The user may then adapt their actions and the content accordingly. The user may further be provided, by the user device, with the option to replace abusive content, such as abusive text, with non-abusive content, such as non-abusive emojis, expressing a similar sentiment. The user device may also be configured to check the modified content to ensure the user has not attempted to obfuscate the abusive content, for example so that a human can still understand the abusive content.

The functionality described herein can be performed, at least in part, by one or more computer program product components such as software components. According to an embodiment, the apparatus 100 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An apparatus for content submission, comprising:
at least one memory storing processor-executable instructions; and
at least one processor coupled to the at least one memory and configured, when executing the processor-executable instructions, to:
facilitate provision of a content;
utilize a classification model, stored within the at least one memory, to provide at least one classification score for the content to indicate whether the content conforms with moderation;
based on the at least one classification score, facilitate submission of the content from the apparatus to at least one external system for publication.

2. The apparatus according to claim 1, wherein the at least one processor is configured, when executing the processor-executable instructions, to facilitate submission of the content from the apparatus to the at least one external system for human moderation.

3. The apparatus according to claim 2, wherein the at least one processor is configured, when executing the processor-executable instructions, to facilitate the submission of the content from the apparatus to the at least one external system for human moderation if the at least one classification score is higher than or equal to a first threshold value and lower than or equal to a second threshold value, the second threshold value being higher than the first threshold value.

4. The apparatus according to claim 3, wherein the at least one processor is configured, when executing the processor-executable instructions, only facilitate the submission of the content from the apparatus to the at least one external system for human moderation based on an input from a user of the apparatus.

5. The apparatus according to claim 1, wherein the at least one processor is configured, when executing the processor-executable instructions, to facilitate the submission of the content from the apparatus to the at least one external system for publication if the at least one classification score fulfils at least one first threshold criterion.

6. The apparatus according to claim 1, wherein the at least one processor is configured, when executing the processor-executable instructions, to prevent the submission of the content from the apparatus to the at least one external system for publication if the at least one classification score fulfils at least one second threshold criterion.

7. The apparatus according to claim 1, wherein the at least one processor is configured, when executing the processor-executable instructions, to prevent, based on the at least one classification score, the submission of the content from the apparatus to the at least one external system for publication and, instead, prompt a user of the apparatus to modify the content to provide a modified content.

8. The apparatus according to claim 7, wherein the at least one processor is configured, when executing the processor-executable instructions, to provide at least one automated suggestion for the user for the modified content.

9. The apparatus according to claim 7, wherein the at least one processor is configured, when executing the processor-executable instructions, to perform obfuscation detection for the modified content.

10. The apparatus according to claim 6, wherein the at least one processor is configured, when executing the processor-executable instructions, in response to the prevention of the submission of the content from the apparatus to the at least one external system for publication, to facilitate the submission of the content from the apparatus to the at least one external system for human moderation based on an input from a user of the apparatus.

11. A method for content submission, comprising:
facilitating provision of a content at an apparatus;
utilizing a classification model, at the apparatus, to provide at least one classification score for the content to indicate whether the content conforms with moderation; and
based on the at least one classification score, facilitating submission of the content from the apparatus to at least one external system for publication.

12. The method according to claim 11, further comprising:
facilitating submission of the content from the apparatus to the at least one external system for human moderation.

13. The method according to claim 12, wherein the step of facilitating comprises:
facilitating the submission of the content from the apparatus to the at least one external system for human moderation if the at least one classification score is higher than or equal to a first threshold value and lower than or equal to a second threshold value, the second threshold value being higher than the first threshold value.

14. The method according to claim 13, wherein the step of facilitating comprises:
only facilitating the submission of the content from the apparatus to the at least one external system for human moderation based on an input from a user of the apparatus.

15. The method according to claim 11, further comprising:
facilitate the submission of the content from the apparatus to the at least one external system for publication if the at least one classification score fulfils at least one first threshold criterion.

16. The method according to claim 11, further comprising:
preventing the submission of the content from the apparatus to the at least one external system for publication if the at least one classification score fulfils at least one second threshold criterion.

17. The method according to claim 11, further comprising:
preventing, based on the at least one classification score, the submission of the content from the apparatus to the at least one external system for publication and, instead, prompt a user of the apparatus to modify the content to provide a modified content.

18. The method according to claim 17, further comprising:
providing at least one automated suggestion for the user for the modified content.

19. The method according to claim 17, further comprising:
performing obfuscation detection for the modified content.

20. The apparatus according to claim 16, further comprising:
in response to the prevention of the submission of the content from the apparatus to the at least one external system for publication, to facilitate the submission of the content from the apparatus to the at least one external system for human moderation based on an input from a user of the apparatus.
